(19) United States
(12) Patent Application Publication
(10) Pub. No.: US 2012/0036523 A1
(43) Pub. Date: Feb. 9, 2012

(54) Adaptive Blending of Recommendation Engines

(75) Inventors: Ofer Weintraub, Hertzliya (IL); Eran Agmon, Hertzliya (IL); Adi Eshkol, Hanna (IL)

(73) Assignee: Orca Interactive Ltd., Ra'anana (IL)

(21) Appl. No.: 13/142,940

(22) PCT Filed: Jan. 1, 2009
(86) PCT No.: PCT/IL2009/000003

§ 371 Date: Sep. 29, 2011

(51) Int. Cl. H04N 21/25

(52) U.S. Cl. 725/9

(57) ABSTRACT

A computer implemented data processing system for adaptively blending a plurality of content recommendation engines. The system comprising: a computer implemented blending module; a plurality of computer implemented recommendation engines in operative association with the blending module; a user terminal in communication with the blending module, wherein the plurality of recommendation engines are in operative association with a content repository; and wherein the user terminal is operable to detect a particular user profile of a particular user associated therewith and deliver the particular user profile to the blending module; and wherein each recommendation engine is associated with specific predefined recommendation rules and operable to select particular content from the content repository in accordance with a particular user profile and predefined recommendation rules; and wherein the blending module is operable to adaptively assign weights to the plurality of recommendation engines for each particular user, responsive to the particular user profile thereof.

### BACKGROUND

1. Technical Field

The present invention relates to the field of content management and content recommendations, and more particularly, to content management in televisions.

2. Related Art

Prior to setting forth the background of the related art, it may be helpful to set forth definitions of certain terms that will be used hereinafter.

The term “recommendation engine” or “recommender system” as used herein in this application, is defined as a specific type of information processing and information filtering (IF) techniques that attempt to present information items (movies, music, books, news, images, web pages) that are likely to be of interest to a user. Typically, a recommendation engine would rely on various parameters in an effort to predict specific content for a specific user. These parameters may include but not limited to content metadata relations, user profile and user preferences, usage history and item correlations, users similarity, content popularity, content clustering and user's social recommendations.

The term “user profile” or simple “profile” as used herein in this application, is defined as a set of predefined parameters that are used to describe a user. In the context of content management, a profile is created for each user so that content is delivered to a particular user in view of his or her profile. In creating a user profile in a recommendation engine a distinction is made between explicit and implicit forms of data collection. Explicit data collection may comprise: asking a user to rate an item on a sliding scale; asking a user to rank a collection of items from favorite to least favorite; presenting two items to a user and asking him/her to choose the best one; asking a user to create a list of items that he/she likes or ask a user to recommend content to a list of friends. Implicit data collection may comprise: observing the items that a user views in an online store; analyzing item/user viewing times; keeping a record of the items that a user purchases online; obtaining a list of items that a user has listened to or watched on his/her computer; analyzing the responsiveness of a user to a set of recommendations from certain type and analyzing the user's social network and discovering similar likes and dislikes. Additionally, the profile may not be generated exclusively for a particular single device associated with a single user. Rather, it may be acquired by other means, such as by integration with external profile repository.

One of the challenges of the recommendation engines is to adjust the right recommendation engine to a particular user having a specific profile. Several attempts to deal with the adaptive nature of recommendation engines are known in the art.

U.S. Pat. No. 7,231,419 which is incorporated by reference herein in its entirety discloses a system and method for employing a number of producer modules to produce and deliver recommendations to a requester. Each of the recommendations having associated therewith a confidence level. Each of the producer modules having associated therewith a weighting value. The confidence levels in each of the recommendations produced by the producers being modified based on weighting value associated with the producer that produced the produced recommendation. The weighing values associated with each of the producer modules being modified based on information from the requester related to the recommendations delivered to the requester. The recommendation system includes a plurality of producer modules and a recommendation engine. Information from the requester system related to the list of survived recommendations transmitted to the requester system.

U.S. Pat. No. 6,321,221 which is incorporated by reference herein in its entirety discloses a system, method and article of manufacture for generating a serendipity-weighted recommendation output set to a user based, at least in part, on a serendipity function. The system includes a processing system of one or more processors configured to receive applicable data that includes item recommendation data and community item popularity data. The processing system is also configured to produce a set of item serendipity control values in response to the serendipity function and the community item popularity data, and to combine the item recommendation data with the set of item serendipity control values to produce a serendipity-weighted and filtered recommendation output set. The method includes receiving applicable data by the processing system, including inputting item recommendation data and community item popularity data. The method further includes generating a set of item serendipity control values in response to the community item popularity data and a serendipity function, using the processing system, and combining the item recommendation data and the set of item serendipity control values to produce a serendipity-weighted and filtered item recommendation output set, also using the processing system.

US Patent Publication No. US2007094066 which is incorporated by reference herein in its entirety discloses a recommendation system that used a blend of technologies from statistics, information theory, and graph theory to quantify and discover patterns in relationships between entities, such as products and customers, as evidenced by purchase behavior. The system employs information-theoretic notions of consistency and similarity, which allows robust statistical analysis of the true, statistically significant, and logical associations between products.

### BRIEF SUMMARY

According to one aspect of the invention there is provided a computer implemented data processing system for adaptively blending a plurality of content recommendation engines, the system comprising: a computer implemented blending module; a plurality of computer implemented recommendation engines in operative association with the blending module; at least one user terminal in communication with the blending module, wherein the plurality of recommendation engines are in operative association with a content repository; and wherein the at least one user terminal is operable to detect a particular user profile of a particular user associated therewith and deliver the particular user profile to the blending module; and wherein each recommendation engine is associated with specific predefined recommendation rules and is further operable to select particular content from the content repository in accordance with a particular user profile or the predefined recommendation rules; and wherein the blending module is operable to adaptively assign weights to the plurality of recommendation engines for each particular user, responsive to the particular user profile thereof.

According to another aspect of the invention there is provided a computer implemented method of adaptively blending a plurality of content recommendation engines, and delivering recommended content to at least one user, the method comprising: periodically determining a user profile of at least one particular user; blending a plurality of recommendation engines in accordance of the user profile of the at least one user; applying each recommendation engine in accordance with the blending and particular predefined recommendation rules associated with the recommendation engine thereby producing blended content; and delivering, over a user terminal, the blended content to at least one user.

According to yet another aspect of the invention there is provided a computer program product, comprising a computer usable medium having a computer readable program code embodied therein, the computer readable program code adapted to be executed to implement a method of adaptively blending a plurality of content recommendation engines, and delivering recommended content to at least one user, the method comprising: periodically determining a user profile of at least one particular user; blending a plurality of recommendation engines in accordance of the user profile of the at least on user; applying each recommendation engine in accordance with the blending and particular predefined recommendation rules associated with the recommendation engine thereby producing blended content; and delivering, over a user terminal, the blended content to at least one user.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram of a recommendation system having an adaptive recommendation blending functionality according to the present invention; and

FIG. 2 is a high level flowchart illustrating a method according to some embodiments of the present invention.

FIG. 3 is a high level flowchart illustrating a method according to additional embodiments of the present invention.

FIG. 4 is a high level flowchart illustrating a method according to yet additional embodiments of the present invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

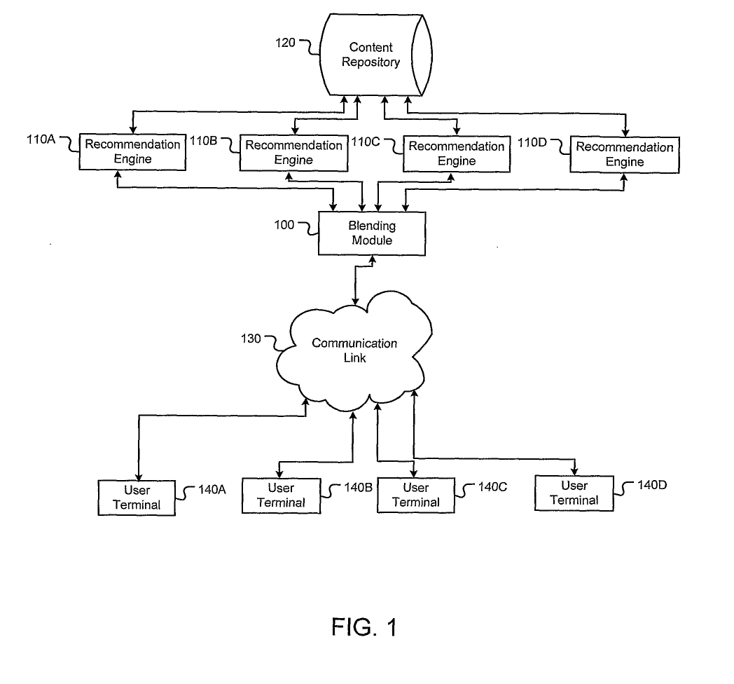

FIG. 1 is a high level schematic block diagram of a computer implemented data processing system for adaptively blending a plurality of content recommendation engines according to some embodiments of the present invention. The system comprises: a computer implemented blending module 100; a plurality of computer implemented recommendation engines 110A-110D in operative association with blending module 100; at least one user terminal 140A-140D in communication with blending module 100, wherein plurality of recommendation engines 110A-1100 are in operative association with a content repository 120.

In operation, at least one user terminal 140A-140D is operable to detect a particular user profile of a particular user associated therewith and deliver the particular user profile to the blending module 100. Each recommendation engine of 110A-110D is associated with specific predefined recommendation rules and is further operable to select particular content from the content repository 120 in accordance with a particular user profile and the predefined recommendation rules. Blending module 100 is operable to adaptively assign weights to plurality of recommendation engines 110A-1100 for each particular user, responsive to the particular user profile thereof.

According to some embodiments of the invention, the user terminal may comprise a television, a personal computer, a PDA, a cellular communication device. Further, the data processing system may be implemented within a Video on Demand (VOD) or Content on Demand (COD) system. Alternatively, the content transmitted would be real-time content streaming (e.g. “Live content”, series, and catch-up TV). Additionally, content repository 120 may comprise any multimedia content such as video, audio, and advertisements.

According to some embodiments of the invention, the user terminal is operable, in cooperation with the data processing system to manage video content and advertisement delivery to the user. Parameters and user profile according to which blending module 100 may be adapted to weigh each recommendation engine of 110A-110D may comprise: preferred genres; content tagging; psychological traits (e.g., preference to new movies, purchase frequency, genre distribution, responsiveness to recommendation); community association; time and location based association; demographics; the type of the proposed items; and previous iterations of the personal response function.

According to some embodiments of the invention the recommendation rules are explicit and may comprise: asking a user to rate an item on a sliding scale; asking a user to rank a collection of items from favorite to least favorite; presenting two items to a user and asking him/her to choose the best one; asking a user to create a list of items that he/she likes.

According to some embodiments of the invention the recommendation rules are implicit and may comprise: data collection may comprise: observing the items that a user views in an online store; analyzing item/user viewing times; keeping a record of the items that a user purchases online; obtaining a list of items that a user has listened to or watched on his/her computer; analyzing the user responsiveness to different recommendation types, and analyzing the user's social network and discovering similar likes and dislikes.

According to some embodiments of the invention, the user profile is deduced according to the user's behavior by applying statistical analysis corresponding to predefined periods. Furthermore, the blending module may be apply a learning process for deducing recommendation rules for each recommendation engine from each particular user's behavior.

According to some embodiments of the invention, blending module 100 may be further arranged to be responsive to the system's constraints in view of the user's account or subscription by filtering out a particular recommendation. Specifically, in the case that a particular content is in line with a particular user's profile, a specific recommendation might be favorable beyond the user's subscription; therefore blending module 100 will filter it out.

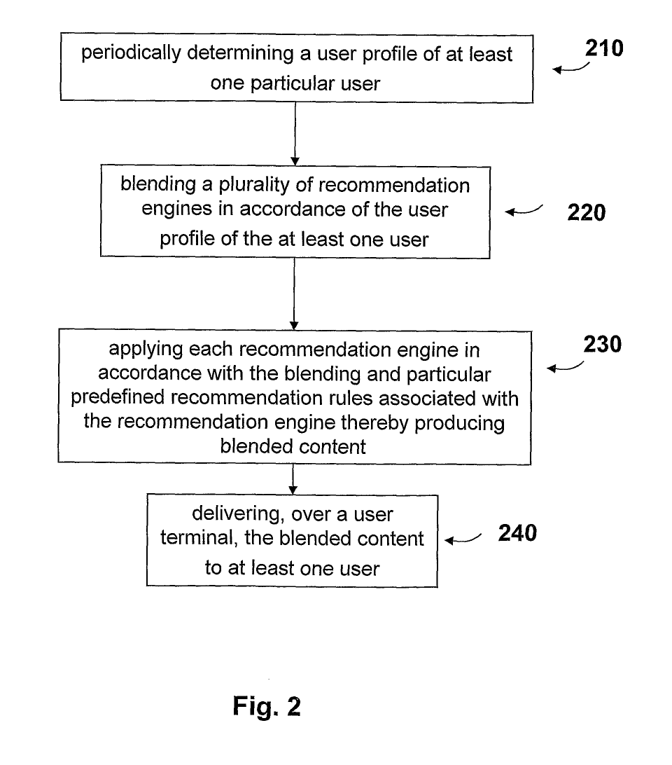

FIG. 2 is a high level flowchart illustrating a computer implemented method of adaptively blending a plurality of content recommendation engines, and delivering recommended content to at least one user. The method comprising: periodically determining a user profile of at least one particular user 210; blending a plurality of recommendation engines in accordance of the user profile of the at least one user 220; applying each recommendation engine in accordance with the blending and particular predefined recommendation rules associated with the recommendation engine thereby producing blended content 230; and delivering, over a user terminal, the blended content to at least one user 240.

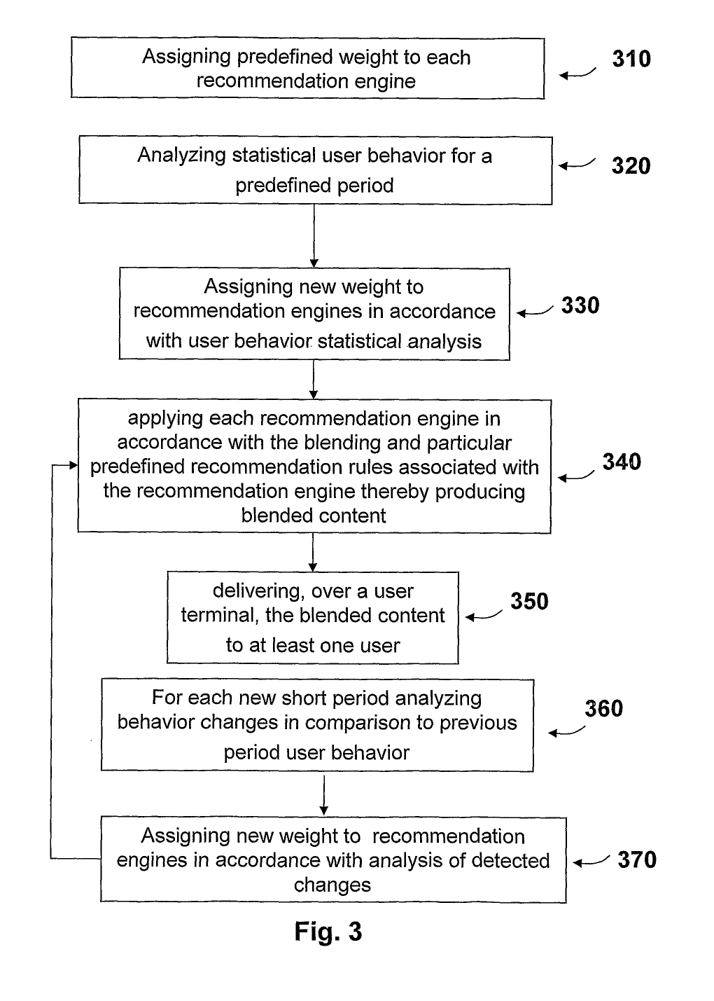

FIG. 3 is a flowchart illustrating a computer implemented method of some embodiments of the invention, the method further comprises: Assigning pre-defined weight to each recommendation engine 310, analyzing statistical user behavior for a predefined large period 320, assigning new weight to recommendation engines in accordance with user behavior statistical analysis 330, applying each recommendation engine in accordance with the blending and particular predefined recommendation rules associated with the recommendation engine thereby producing blended content 340, delivering, over a user terminal the blended content to at least one user 350, for each new short period analyzing user behavior changes in comparison to previous period behavior 360, assigning new weight to recommendation engines in accordance with analysis of detected changes 370. At every predefined large period is conducted new statistical analysis for assigning new weight. For every short period only the changes in behavior is checked for reducing the processing time of large statistical analysis.

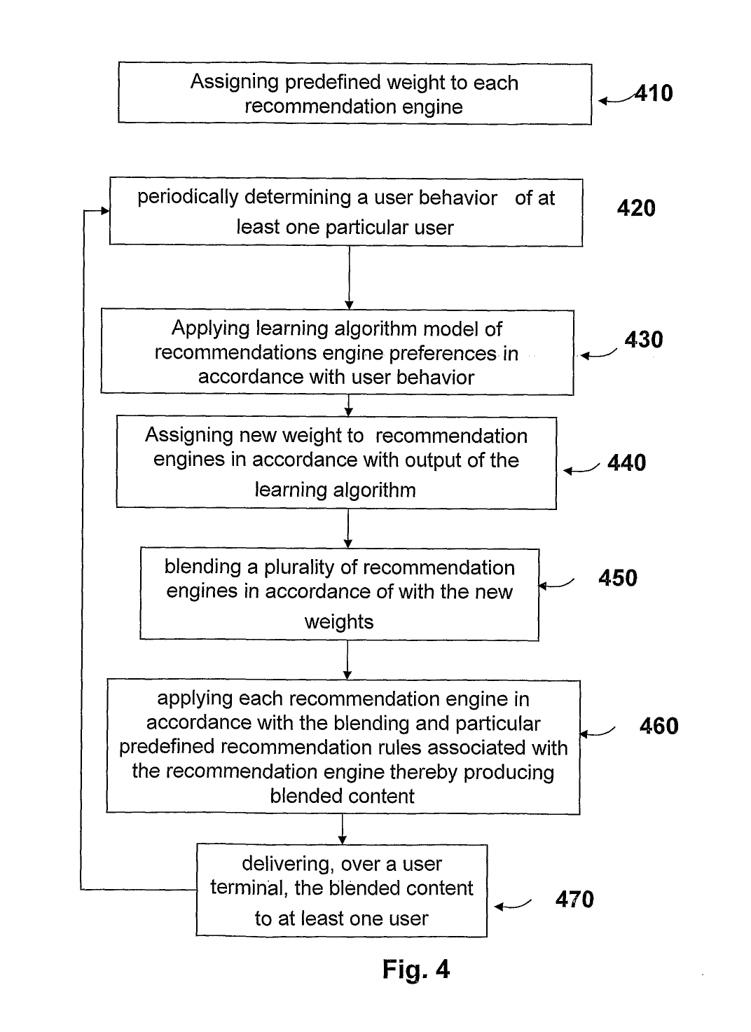

FIG. 4 is a flowchart illustrating a computer implemented method of some embodiments of the invention, the method further comprises: Assigning pre-defined weight to each recommendation engine 410, periodically determining a user behavior of at least one particular user 420, Applying learning algorithm model of recommendations engine preferences in accordance with user behavior 430, Assigning new weight to recommendation engines in accordance with output of the learning algorithm 440, blending a plurality of recommendation engines in accordance with the new weights 450, applying each recommendation engine in accordance with the blending and particular predefined recommendation rules associated with the recommendation engine thereby producing blended content 460, delivering, over a user terminal, the blended content to at least one user 470.

The learning module may implemented utilizing neural network methodologies, by assigning weight to each recommendation engine and conducting training sets of known user behavior for creating behavioral prediction models of users preferences. The behavior models which are represented as neural network are updated at each pre-defined period in according with user actual behavior.

According to some embodiments of the present invention it is suggested to conduct trend analysis for detecting behavioral trends thorough large time. E.g. one year for better tuning of the recommendation engine weights at each season of the year, for example at summer time there may a trend of families movies. In another example a trend analysis may reveal that some user profiles are rather static whereas other profiles are dynamic. It will then be possible to re-calculate the blend only for the dynamic profiles thus boosting the system performance.

According to some embodiments of the present invention it is suggested to conduct cluster analysis of groups of user behavior according to their explicit profile, such cluster analysis can improve the accuracy of the recommendation engines blending, proving better prediction to user preferences and at the same time improve overall performance.

Advantageously, various embodiments of the invention are aimed for the Content on Demand (COD) and Video on Demand (VOD) markets. However, it is understood that the necessary modification may be performed in order to support any kind of content management, in any standard. The functionality of the present invention serves as in cooperation with existing content management and distribution infrastructure.

According to some embodiments of the invention, the system can be implemented in digital electronic circuitry, or in computer hardware, firmware, software, or in combinations thereof. Preferably, adaptive blending module and each of the recommendation engines operatively associated therewith are implemented as a computer readable mediums adopted to operate over a computer, either a general purpose processor or application specific processor.

Suitable processors modules within the ASIC implementation of the base band processors include, by way of example, digital signal processors (DSPs) but also general purpose microprocessors, and field programmable gate array (FPGA). Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files. Storage devices suitable for tangibly embodying computer program instructions and data include all forms of non-volatile memory, including by way of example semiconductor memory devices, such as EPROM, EEPROM, and flash memory devices.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments.

Other possible variations, modifications, and applications are also within the scope of the invention. Accordingly, the scope of the invention should not be limited by what has thus far been described, but by the appended claims and their legal equivalents.

What is claimed is:

1. A computer implemented data processing system for adaptively blending a plurality of content recommendation engines, the system comprising:
a computer implemented blending module;
a plurality of computer implemented recommendation engines in operative association with the blending module;
at least one user terminal in communication with the blending module,
wherein the plurality of recommendation engines are in operative association with a content repository;
and wherein the at least one user terminal is operable to detect a particular user profile of a particular user associated therewith and deliver the particular user profile to the blending module;
and wherein each recommendation engine is associated with specific predefined recommendation rules and is further operable to select particular content from the content repository in accordance with a particular user profile and the predefined recommendation rules;
and wherein the blending module is operable to adaptively assign updated weights to the plurality of recommendation engines for each particular user for corresponding to predefined time period, responsive to the particular user profile thereof.

2. The data processing system according to claim 1, wherein the user terminal is a television.

3. The data processing system according to claim 1, wherein the data processing system is implemented within a Video on Demand (VOD) or Content on Demand (COD) system.

4. The data processing system according to claim 1, wherein the data processing system is implemented within real-time content streaming environment, wherein the content comprises at least one of: live content, series, catch-up television.

5. The data processing system according to claim 1, wherein the user profile and the corresponding recommendation rules are explicit.

6. The data processing system according to claim 1, wherein the user profile and the corresponding recommendation rules are implicit.

7. The data processing system according to claim 1, wherein the user profile is deduced according to the user's behavior.

8. The data processing system according to claim 7, wherein the blending module process of assigning weight is based on statistical analysis of user's behavior for predefined period of time.

9. The data processing system according to claim 8, wherein for a short time period the blending module process of assigning weights include identifying of user behavior changes in comparison with previous periods.

10. The data processing system according to claim 7, wherein the blending module process of assigning weight is based on a learning process for predicting user preferences.

11. The data processing system according to claim 10, wherein the learning model is neural network algorithm, providing prediction model of neural networks which is based given training sets of known user behaviors.

12. The data processing system according to claim 1, wherein teach user is associated with a user account or subscription and wherein the blending module is further arranged to be responsive to the data processing system's constraints in view of the user's account or subscription by filtering out a particular recommendation.

13. A computer implemented method of adaptively blending a plurality of content recommendation engines, and delivering recommended content to at least one user, the method comprising:
periodically determining a user profile of at least one particular user;
assigning updated weights to the plurality of recommendation engines for each particular user for corresponding to predefined time period, responsive to the particular user profile;
blending a plurality of recommendation engines in accordance with assigned weights of each recommendation engine the user profile of the at least on user;
applying each recommendation engine in accordance with the blending and particular predefined recommendation rules associated with the recommendation engine thereby producing blended content; and
delivering, over a user terminal, the blended content to at least one user.

14. The computer implemented method according to claim 13, further comprising:
deducing at least one user profile according to the user's behavior.

15. The computer implemented method according to claim 14, further comprising the step of statistical analyzing of user's behavior for predefined period of time.

16. The computer implemented method according to claim 15, further comprising the step of identifying of user behavior changes in a short time period in comparison with previous periods, wherein assigning weights to the recommendation engines is based on analysis of said identified changes.

17. The computer implemented method according to claim 13, wherein the step of assigning weight is based on a learning process for predicting user preferences.

18. The computer implemented method according to claim 17, wherein the learning model is neural network algorithm, providing prediction model of neural networks which is based given training sets of known user behaviors.

19. The computer implemented method according to claim 13, wherein the method is implemented within an existing Video on Demand (VOD) or content on Demand (COD).

20. The computer implemented method according to claim 13, wherein the method is implemented within real-time content streaming environment, wherein the content comprises at least one of: live content, series, catch-up television.

21. The computer implemented method according to claim 13, further comprising the step of conducting analysis for clusters of predefined groups of users having common profiles, wherein the wherein the step of assigning weight is adjusted in accordance with said cluster analysis.
